(19) United States
(12) Patent Application Publication
(10) Pub. No.: US 2012/0124909 A1
(43) Pub. Date: May 24, 2012

(54) FLUSH PANEL ADJUSTMENT ASSEMBLY FOR A LIFT AND SLIDE DOOR

(75) Inventors: Kyle Koch, Warroad, MN (US); Bradley D. Woodward, Warroad, MN (US)

(73) Assignee: Marvin Lumber and Cedar Company, d/b/a, Warroad, MN (US)

(21) Appl. No.: 13/302,550

(22) Filed: Nov. 22, 2011

Related U.S. Application Data
(60) Provisional application No. 61/417,056, filed on Nov. 24, 2010.

(51) Int. Cl. E06B 3/32; E05B 1/00

(52) U.S. Cl. 49/128; 49/460; 49/506

(57) ABSTRACT

A fenestration assembly includes a first panel movably coupled within a frame. The first panel includes a first panel exterior surface and a first panel interior surface. A second panel is coupled within the frame. A first escutcheon is coupled along one of the first panel exterior surface or the first panel interior surface. The first escutcheon is flush mounted relative to the first panel exterior surface or the first panel interior surface, and the first escutcheon faces the second panel. A panel adjustment mechanism is disposed within the first panel and is configured to move the first panel from a static orientation to a movable orientation. The panel adjustment mechanism is accessible through the first escutcheon. The first panel is coextensive with the second panel in an open position, and the first escutcheon is concealed between the first and second panels.

### CLAIM OF PRIORITY

This patent application claims the benefit of priority, under 35 U.S.C. §119(e), to U.S. Provisional Patent Application Ser. No. 61/417,056, entitled “FLUSH HANDLE ASSEMBLY FOR A LIFT AND SLIDE DOOR,” filed on Nov. 24, 2010 (Attorney Docket No. 1261.150PRV), which is hereby incorporated by reference herein in its entirety.

### TECHNICAL FIELD

Sliding windows and doors.

### BRIEF DESCRIPTION OF THE DRAWINGS

A more complete understanding of the present subject matter may be derived by referring to the detailed description and claims when considered in connection with the following illustrative Figures. In the following Figures, like reference numbers refer to similar elements and steps throughout the Figures.

FIG. 1 is a front view of one example of a fenestration assembly including at least one sliding panel.

FIG. 2 is a detailed perspective view from the interior of one example of an panel adjustment assembly with a selectively removable handle.

FIG. 3 is a detailed perspective view from the exterior of the panel adjustment assembly of FIG. 3 with the selectively removable handle coupled at the exterior.

FIG. 4A is a cross-sectional side view of one example of a panel adjustment mechanism configured to lift and permit sliding movement of the sliding panel within a frame.

FIG. 4B is a detailed perspective view of the panel adjustment mechanism shown in FIG. 4A in an elevated configuration.

FIG. 4C is an exploded perspective view of a linkage cover containing a linkage therein.

FIG. 4D is a detailed exploded view of the linkage cover containing the linkage and a panel operator of the panel adjustment assembly shown in FIG. 4C.

FIG. 4E are plan and side views of one example of a linkage for a panel adjustment mechanism.

FIG. 4F is a side view of one example of a panel operator coupled with a linkage within a linkage cover.

FIG. 5A is a detailed perspective interior view of the panel adjustment assembly of FIG. 2 with the handle selectively removed.

FIG. 5B is a detailed perspective exterior view of the panel adjustment assembly of FIG. 3 with the handle selectively removed.

FIG. 6 is a front view of a door assembly with the sliding panel in an open position with at least one of the escutcheons concealed between the sliding panel and a static panel.

FIG. 7 is a perspective view of the door assembly of FIG. 6 with an edge of the static panel flush with an edge of the sliding panel adjacent to the panel adjustment assembly.

FIG. 8A is a front view of one example of an exterior escutcheon with a pendulum rotating cover.

FIG. 8B is a front view of another example of an exterior escutcheon with a rotating disc cover.

FIG. 8C is a front view of yet another example of an exterior escutcheon with a sliding cover.

FIG. 8D is a front view of still another example of an exterior escutcheon with a webbed grommet cover.

FIG. 9 is a cross sectional view of one example of a multi-panel fenestration assembly including two movable panels and a panel adjustment assembly.

FIG. 10 is a block diagram showing one example of a method for making a fenestration assembly including a panel adjustment assembly.

FIG. 11 is a block diagram showing one example of a method for using a fenestration assembly including a panel adjustment assembly.

Elements and steps in the Figures are illustrated for simplicity and clarity and have not necessarily been rendered according to any particular sequence. For example, steps that may be performed concurrently or in different order are illustrated in the Figures to help to improve understanding of examples of the present subject matter.

### DESCRIPTION OF THE DRAWINGS

In the following detailed description, reference is made to the accompanying drawings which form a part hereof, and in which is shown by way of illustration specific examples in which the subject matter may be practiced. These examples are described in sufficient detail to enable those skilled in the art to practice the subject matter, and it is to be understood that other examples may be utilized and that structural changes may be is made without departing from the scope of the present subject matter. Therefore, the following detailed description is not to be taken in a limiting sense, and the scope of the present subject matter is defined by the appended claims and their equivalents.

The present subject matter may be described in terms of functional block components and various processing steps. Such functional blocks may be realized by any number of techniques, technologies, and methods configured to perform the specified functions and achieve the various results.

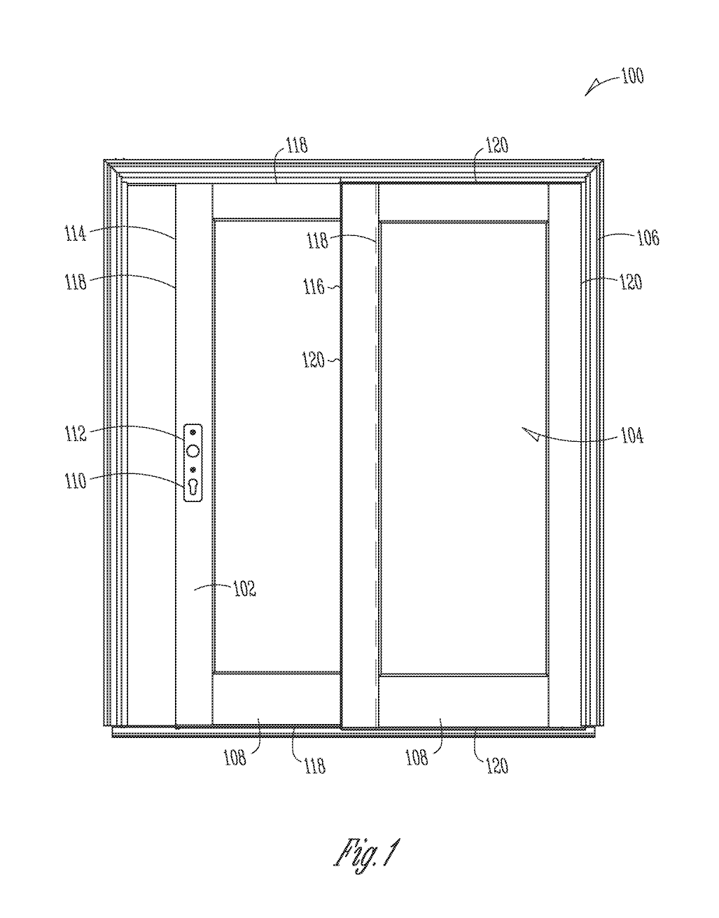

FIG. 1 shows one example of a fenestration assembly 100 including a plurality of panels at least one of which, for example, the first panel 102 is slidable within a frame 106. As shown in the example in FIG. 1, the first panel 102 is a sliding panel within the frame 106 and the second panel 104 is a static panel held at a fixed static position within the frame. The first and second panels 102, 104 each include panel interior surfaces 108 and panel exterior surfaces as will be described in further detail below. At least the first panel 102 of the fenestration assembly 100 includes an interior or exterior operated panel adjustment assembly (e.g., a panel adjustment assembly 110) coupled along the first panel to facilitate the opening and closing of the first panel 102 and storing of the first panel flush with the second panel 104. As shown in FIG. 1, one portion of the panel adjustment assembly 110 includes an interior escutcheon 112 and an opposed exterior escutcheon is optionally provided on the opposing face of the first panel, as will be described in further detail below. In another option, the panel adjustment assembly 110 includes one of the interior escutcheon 112 or the exterior escutcheon. The panel adjustment assembly 110 further includes in one example a panel operator (described below). In one example, one or more of the interior and exterior escutcheon 112 are flush with the corresponding panel interior surface 108 or panel exterior surface of the first panel 102 to facilitate flush positioning of the first panel or stacking with the second panel. Additionally, the positioning of the interior and exterior escutcheons along the first panel, as shown in FIG. 1, permits the flush positioning of a first panel edge 114 and a second panel edge 116 when the first panel 102 is moved into the stacking configuration positioned behind or in front of the static panel 104.

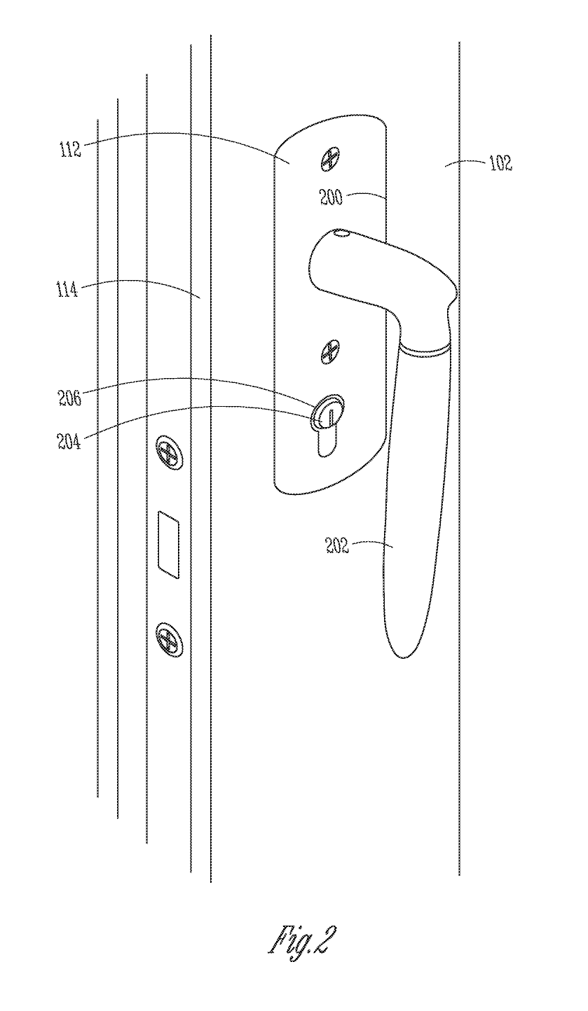

FIG. 2 shows one example of an interior escutcheon 112 of the panel adjustment assembly 110. As shown the interior escutcheon 112 is substantially flush with the first panel 102 including a panel interior surface 108. For instance, the interior escutcheon 112 is positioned within an installation orifice 200 formed with the panel interior surface 108 (e.g., a routed or other opening configured to receive the escutcheon). The interior escutcheon 112 is positioned between the first and second panels 102, 104 (e.g., positioned along the first panel 102) with the interior escutcheon 112 facing the second panel 104. An adjustment handle 202 is shown as selectively coupled with the panel adjustment assembly 110. With the adjustment handle 202 coupled with the interior escutcheon 112 the panel adjustment assembly 110 is in an operation configuration and first panel 102 is operable to transition to a movable configuration. As described in further detail below, the adjustment handle 202 is selectively removable relative to the interior and exterior escutcheons 112 to facilitate coupling and decoupling of the adjustment handle for operation of the first panel 102 from the interior or exterior side. Additionally, the readily selective decoupling of the adjustment handle 202 from the interior or exterior escutcheons 112 removes any features from the panel adjustment assembly prior to positioning of the first panel 102 in the stacking relationship with the second panel 104. Stated another way, removal of the adjustment handle 202 permits flush positioning of the first panel 102 with the second panel 104 and thereby provides a smooth and aesthetic appearance where the first and second panels are stacked without any staggering of the panels within the frame 106.

As further shown in FIG. 2, the interior escutcheon further presents a key cylinder 204 with an interior key orifice 206. In at least one example, the interior escutcheon 112 and the exterior escutcheon both include the key cylinder 204 with opposed interior and exterior key orifices 206, Provision of key orifices 206 on both sides of the panel adjustment assembly 110 permits locking and unlocking of the first panel 102 from the exterior and interior of the fenestration assembly 100. Optionally, the interior escutcheon 112 includes a dial, lever and the like, such as a thumb turn to facilitate interior actuation of the key cylinder without a key.

FIG. 2 shows a first panel edge 114 of the first panel 102 and the flush character of the interior escutcheon 112. These features in combination with the selectively removable capability of the adjustment handle 202 permit the flush positioning of the first panel edge 114 relative to the second panel edge 116 (described above). Stated another way, the first panel 102 is stackable within the perimeter of the second panel 104 to provide a opening in the fenestration frame 106 that is uninterrupted (free of portions of the first panel extending from the second panel) by any part of the first panel 102. That is to say, the first panel perimeter 118 is coextensive with the second panel perimeter 120. Minimal spacing is provided between the panels (e.g., around 0.125 inches) because of the flush contour of the panel adjustment assembly 110 to substantially avoid a gap between the panels otherwise required with projecting handles, escutcheons and the like. Thick interlocking features between adjacent panels that allow for reception of a handle and projecting features of the panels are thereby avoided.

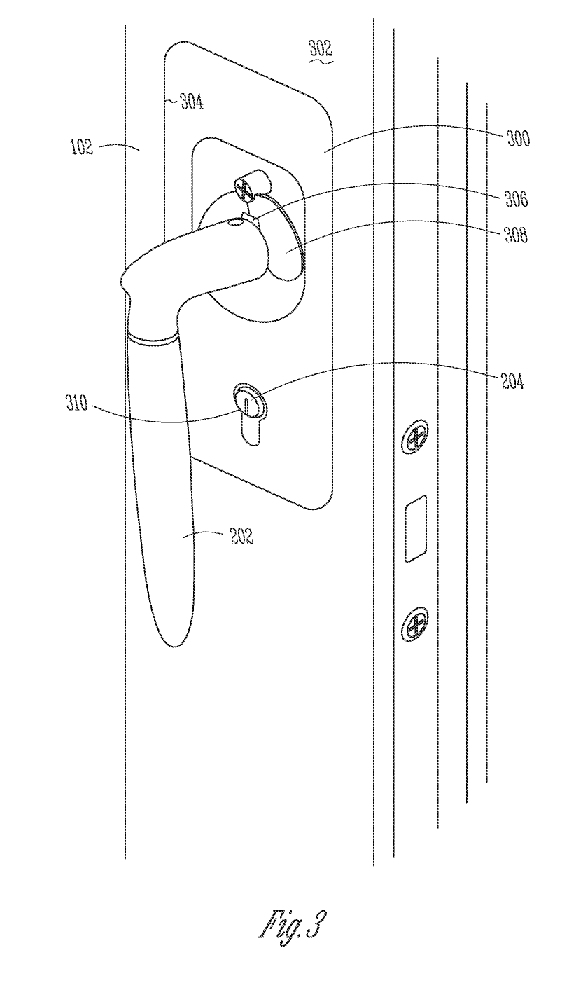

FIG. 3 shows one example of an exterior escutcheon 300 of the panel adjustment assembly 110. As shown in FIG. 3, the exterior escutcheon 300 is flushly mounted with the first panel 102, for instance, the exterior surface 302 of the first panel. In one example, the exterior escutcheon 300 is received within an installation orifice 304 in the exterior surface 302 of the panel 102 (e.g., a routed surface of the first panel). The exterior escutcheon 300 presents an exterior access orifice 306 for coupling of the adjustment handle 202 with the corresponding panel adjustment mechanism (e.g., including a mechanism body and a linkage) of the first panel 102. As shown in FIG. 3, in one example, the exterior escutcheon 300 includes a movable cover 308 configured to cover the exterior access orifice 106 when the adjustment handle 202 is not coupled therein. Stated another way, the movable cover 308 provides protection to the exterior access orifice 306 as well as the interior elements of the panel adjustment mechanism while the adjustment handle 202 is not otherwise coupled within the exterior escutcheon 300. For instance, where the first panel 102 is in a locked and closed position and operation of the panel adjustment mechanism is not desired the movable cover doses the exterior access orifice thereby protecting the interior mechanism until such time that the adjustment handle 202 is again coupled through the exterior access orifice 306.

As further shown in FIG. 3, the exterior escutcheon 300 further provides an orifice for the key cylinder 204 including an exterior key orifice 310. As described previously, the key cylinder 204 extends from the exterior escutcheon 300 to the interior escutcheon 112 and provides a single mechanism for keyed locking and opening of the first panel 102 within the frame 106. Optionally, the interior escutcheon 112 includes a dial, lever and the like, such as a thumb turn to facilitate interior actuation of the key cylinder without a key. The key cylinder 204 ensures that the first panel 102 may not be transitioned from the static position to a movable configuration through operation of the panel adjustment mechanism from the exterior of the fenestration assembly 100. Instead, the key cylinder must first be unlocked before the adjustment handle 202, coupled with the panel adjustment mechanism (described herein), may move the first panel 102 into a movable configuration. The key cylinder 204 provides added security in combination with the first panel 102 that is movable into a coextensive open position with the second panel according to the flush exterior escutcheon and removed adjustment handle 202.

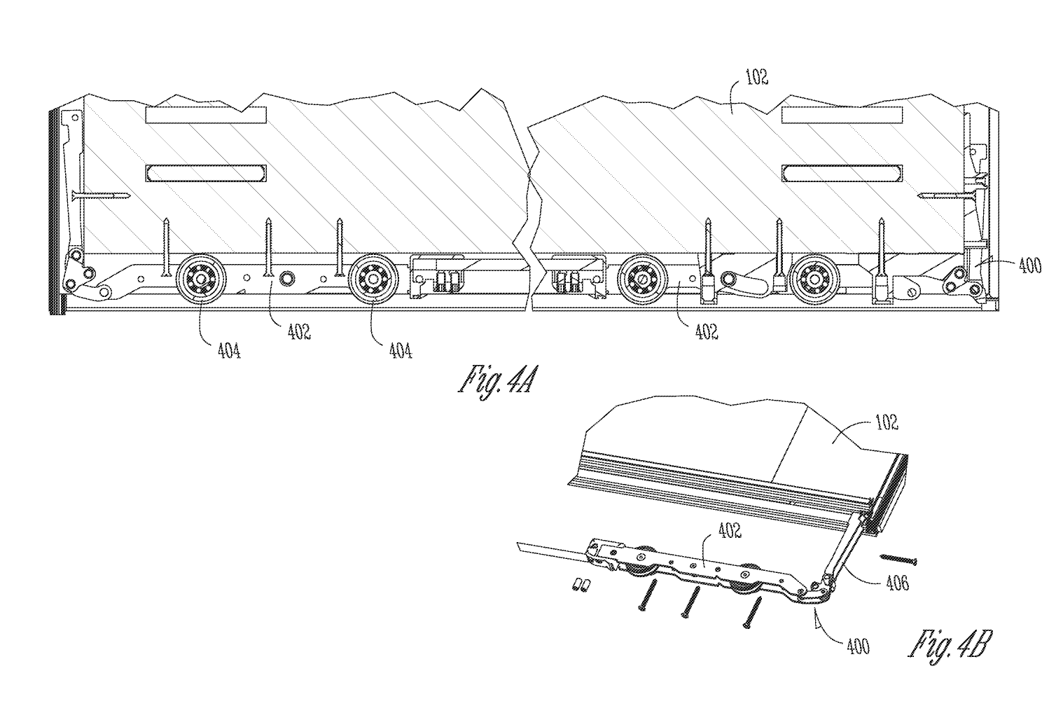

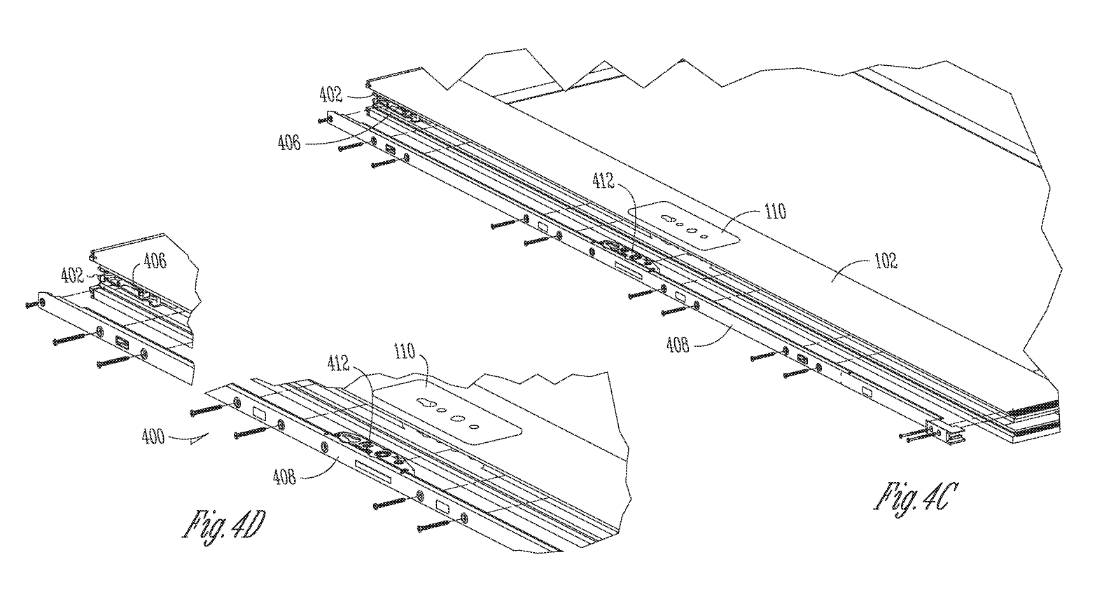

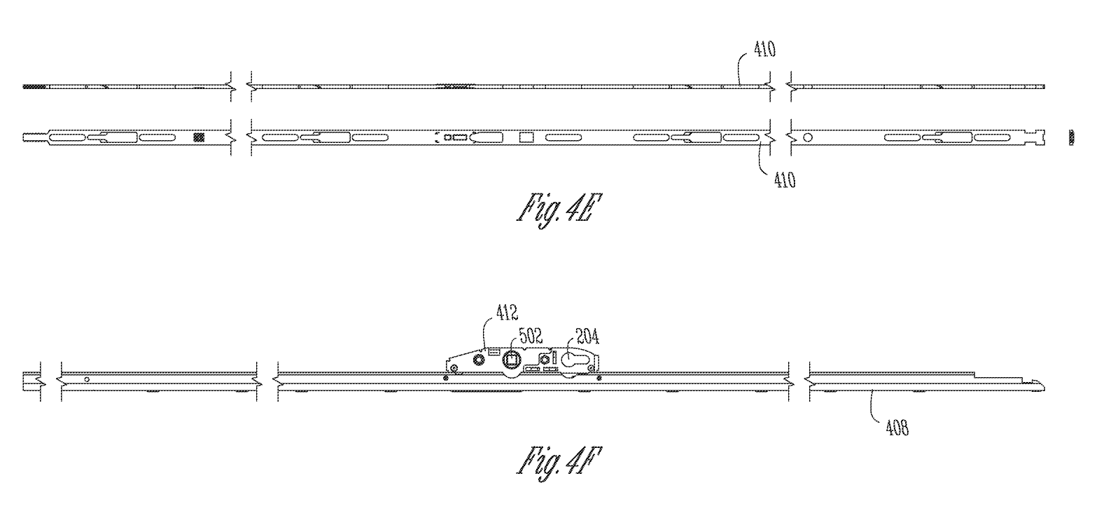

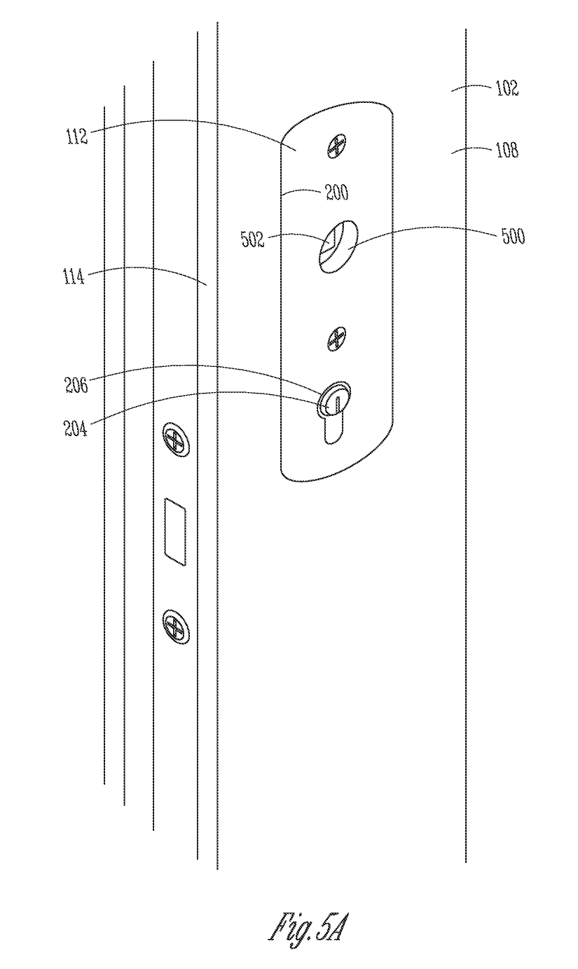

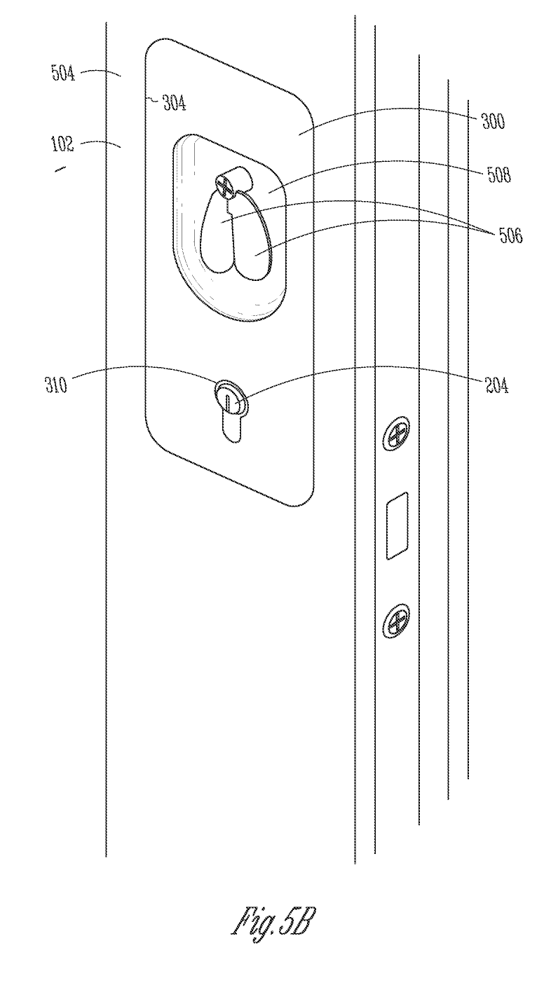

The view shown in FIG. 4A provides one example of a panel adjustment mechanism 400 configured for moving the first panel 102 when operated through the adjustment handle 202 previously described. As shown the panel adjustment mechanism 400 includes a mechanism body 402 and one or more rollers 404 positioned along a bottom surface of the first panel 102. As shown in FIG. 4B, the mechanism body is shown in an actuated orientation with an elevation arm 406 moving the mechanism body 402 as well as the rollers 404 away from the bottom of the first panel 102. Positioning of the mechanism body 402 and the rollers 404 in this actuated orientation moves the first panel 102 in an upward direction and partially decouples the first panel from the frame 106 (See FIG. 1) and allows the mechanism body 402 and the rollers 404 to move the first panel 102 within the frame 106. Stated another way, actuation of the panel adjustment mechanism 400 moves the first panel 102 into a movable configuration. In an unactuated configuration in another example, the first panel 102 is seated along the frame 106 and more resistant to movement (e.g., the panel is fixed, static or requires significant lateral force to move the first panel).

FIGS. 4C, D, E show one example of a linkage 410 housed within a linkage cover 408 connected with the panel adjustment assembly 110 through a panel operator 412. The linkage 410 is shown in FIG. 4E. The linkage 410 and the linkage cover 408 extend from the panel adjustment assembly 110, for instance, the interior and exterior escutcheons 112, 300 and the panel operator 412 to the mechanism body 402, for instance the elevation arm 406, shown at the bottom of the first panel 102 in FIGS. 4A, B. The linkage 410 within the linkage cover 408 is movably coupled along the first panel 102 to facilitate actuation of the mechanism body 402 and the first panel 102 into the movable configuration. Operation of the adjustment handle 202 at the interior or exterior escutcheons 112, 300 with the panel operator 412 operates the linkage 410 and thereby correspondingly operates the mechanism body 402 to move the first panel 102 from a static (e.g., locked) to a rolling or movable configuration. Thereafter, the user is able to use one or more of the adjustment handle 202 or engagement of the hand, for instance with a portion of the first panel 102, to move the first panel 102 relative to the frame 106. For instance, the user will be able to move the first panel 102 into a stacking position with the second panel 104 (the first panel is positioned partly or fully within the perimeter of the second panel).

FIG. 4E shows one example of the linkage 410 configured for coupling between the panel adjustment assembly 110 and the mechanism body 402 (e.g., with the elevation arm 406 interposed between the mechanism body and the linkage 410). The linkage 410 is configured for slidable coupling within the linkage cover 408, previously shown in FIGS. 4C, D and shown again in FIG. 4F. In one example, the linkage 410 is constructed with stainless steel and configured to cooperate with operation of the adjustment handle 202 and the panel operator 412 to elevate the first panel 102 into the movable orientation with the rollers 404 engaged along the frame 106 and the panel 102 free to move laterally within the frame 106.

FIG. 4F shows part of the panel adjustment assembly 110 including the panel operator 412, As described above, the panel operator 412 is retained within the first panel 102 beneath the flush mounted escutcheon including one or both of the exterior and interior escutcheons 300, 112. In combination, the flush mounted escutcheon 300, 112 and the panel operator 412 form the panel adjustment assembly 110. The panel adjustment assembly 110 is flush relative to at least one of the exterior surface 302 or the interior surface 108 of the first panel 102 in the case of the escutcheons 300, 112. The panel operator 412 of the panel adjustment assembly 110 is recessed relative to the exterior surface 302 and the interior surface 108 and housed within the first panel 102. Optionally, the panel operator 412 is part of the panel adjustment mechanism 400.

As shown in FIG. 4F, the panel operator 412 includes the non-circular coupling feature 502 configured for corresponding coupling with the adjustment handle 202. The panel operator 412 is coupled with the linkage 410 and thereby coupled with the panel adjustment mechanism 400 through the linkage 410. Rotation of the non-circular coupling feature 502 with the handle 202 moves the first panel 102 from the static orientation to the movable orientation as described herein. In one option, the panel adjustment assembly 110 includes the key cylinder 204 coupled with one or more of the panel operator 412 and the linkage 410. The key cylinder 204 locks one or more of the linkage 410 and the panel operator 412 and prevents actuation of the first panel 102 into the movable orientation. Operation of the key cylinder 204 correspondingly unlocks one or more of the linkage 410 and the panel operator 412 and thereafter allows actuation of the first panel 102 into the movable orientation. The key cylinder 204, especially where present through the flush mounted exterior escutcheon 300 thereby provides an added security measure in combination with the removable adjustment handle 202 to prevent undesired opening of the fenestration assembly 100.

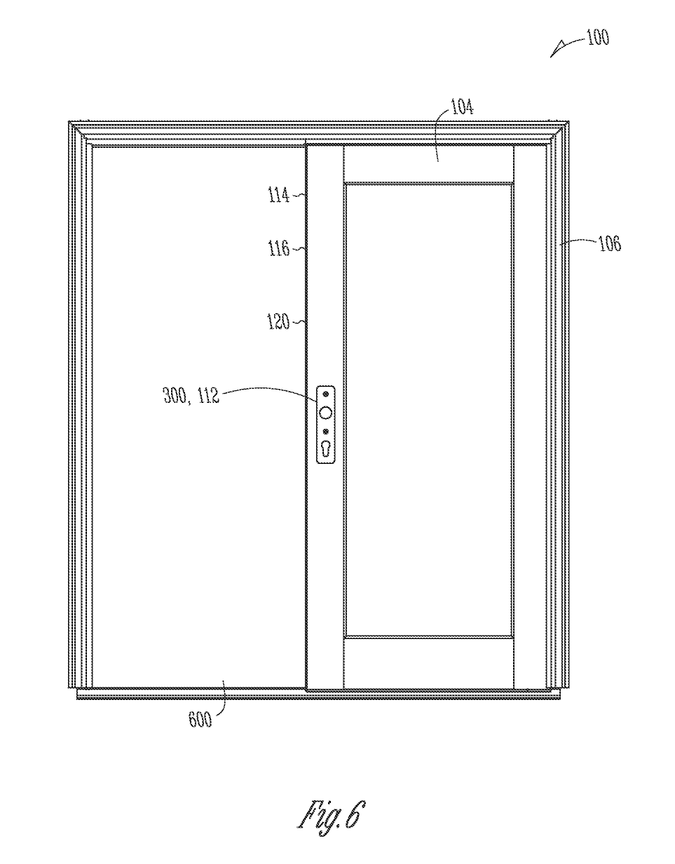

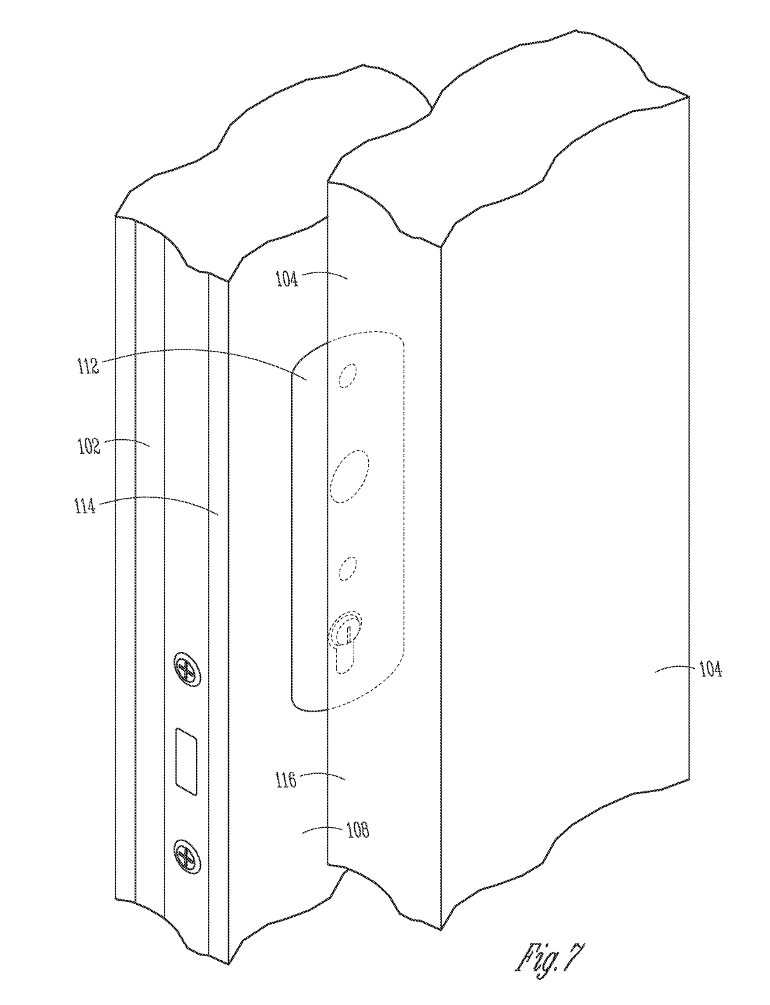

FIG. 5A shows one example of the panel adjustment assembly 110 with the adjustment handle 202 removed from the interior escutcheon 112 (e.g., a flush configuration). As shown the interior access orifice 500 is clear and presents an at least partially viewable square coupling feature 502 for reception of the adjustment handle 202. Because the adjustment handle 202 is received within a non-circular feature 502 and has a corresponding non-circular post rotational movement of the adjustment handle 202 is capable of moving the linkage 410 and the mechanism body 402 (by way of the elevation arm 404) as previously described herein. As further shown in FIG. 5A, the interior escutcheon 112 is substantially flush with the panel interior 108. As described in further detail below, flush positioning of the interior escutcheon 112 with regard to the panel interior 108 permits stacking of the first panel 102 relative to the second panel 104. Stated another way, the first panel 102 is positioned directly behind the second panel 104 (within the second panel perimeter) without a staggered appearance of the first panel 102 extending outside of the border of the second panel 104. Also shown in FIG. 5A, the interior escutcheon 112 presents an interior key orifice 206 of the key cylinder 204. As previously described above, the key cylinder 204 selectively locks the panel adjustment mechanism 400 and thereby substantially prevents or allows movement of the first panel 102 relative to the second panel 104.

FIG. 5B shows the first panel 102 again from the exterior, for instance, the panel exterior 504 is shown. The exterior escutcheon 300 is shown flushly positioned along the panel exterior 504, and in a similar manner to the interior escutcheon 112 the exterior escutcheon 300 provides a flush surface for stacking of the first panel 102 relative to the second panel 104 (e.g., where the panel exterior 504 is adjacent the second panel 104). As with FIG. 5A, the adjustment handle 202 is removed. A movable cover 506 is positioned over the exterior access orifice 306 (See FIG. 3) to protect the access orifice 306 as well as the linkage 410 of the panel adjustment mechanism 400 therein from the elements. As shown in FIG. 5B, the movable cover 506 is positioned within a cover recess 508 in one example. The cover recess 508 recesses the movable cover 506 from the remainder of the exterior escutcheon 300 and the panel exterior 504 to ensure the exterior escutcheon 300 is flush to the first panel 102.

The exterior escutcheon 300 further includes an opening to present the key cylinder 204 extending between the interior and exterior escutcheons 112, 300 of the panel adjustment assembly 110, An exterior key orifice 310 is provided for locking and unlocking of the first panel 102 in an identical manner to locking and unlocking of the first panel through the interior key orifice 206 shown in FIG. 5A.

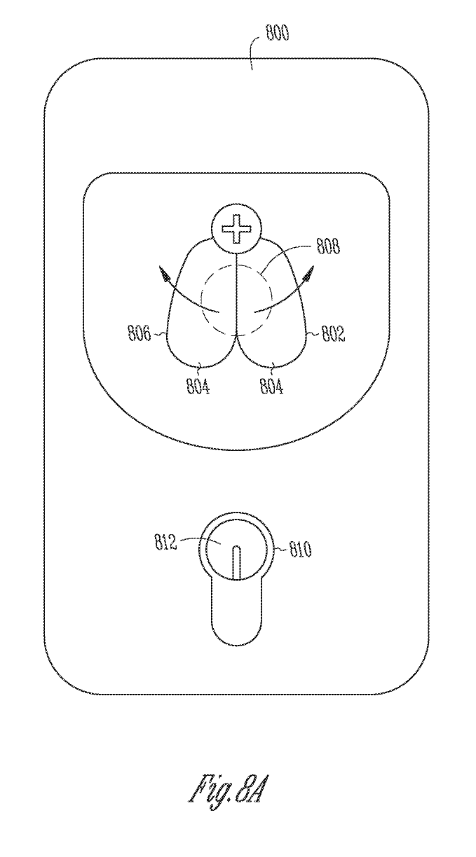

FIG. 6 shows one example of the fenestration assembly previously shown in FIG. 1 where the first panel 102 is stacked behind the second panel 104. As shown in FIG. 6, the first and second panel edges 114, 116 are substantially flush thereby presenting an appearance of a single panel within the frame 106. The appearance of the single panel without a staggered first and second panel 102, 104 provides an aesthetically pleasing appearance to the fenestration assembly 100 that also maximizes the opening 600 of the fenestration assembly 100 while the first panel 102 is in the open configuration. Stated another way, the first panel perimeter 118 of the first panel 102 is substantially received and contained within the second panel perimeter 120 of the second panel 104. As discussed above, the flush mounted interior (or exterior) escutcheon 112 allows for the coextensive positioning of the first panel 102 relative to the second panel 104. Stated another way, the first and second panel perimeters 118, 120 are coextensive in an open configuration thereby concealing the first panel 102 (where the second panel 104 overlies the first panel) and the interior escutcheon 112 and correspondingly maximizing the opening 600 of the fenestration assembly 100. Alternatively, the first panel perimeter 118 of the first panel 102 is more fully received within the second panel perimeter 120 of the second panel 104 than what is otherwise possible with a non-flush handle assembly. In another example, the flush mounted interior escutcheon 112 allows for the positioning of the panel interior 108 of the first panel 102 immediately adjacent to a corresponding surface of the second panel 104 (e.g., the panel exterior surface of the second panel), for instance in surface to surface contact or with immediately adjacent spacing (without contact, such as a space of 0.125 inches).

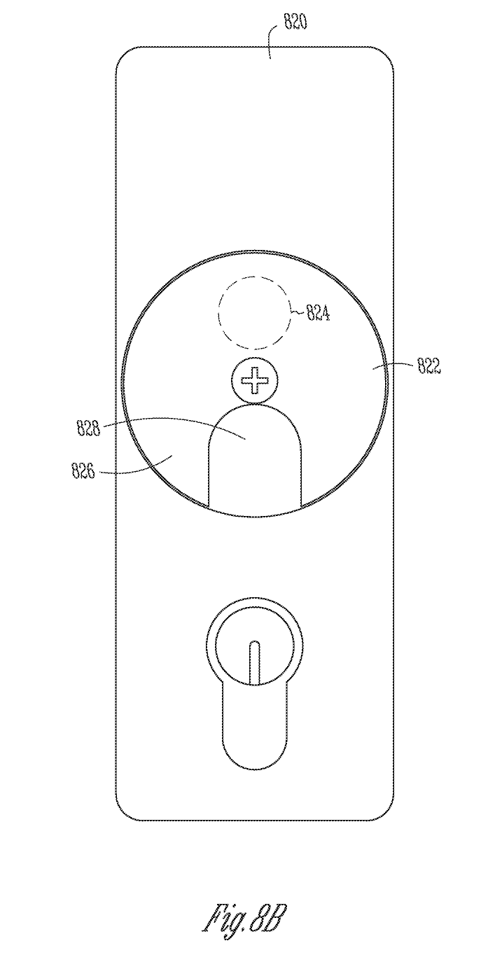

Referring now to FIG. 7, the first and second panels 102, 104 shown in FIG. 6 are shown in perspective with the first panel 102 positioned behind the second panel 104. As previously described, the first and second panel edges 114, 116 are flushly positioned to present the appearance of a single panel within the frame 106. The flush positioning of the first panel edge 114 relative to the second panel edge 116 is accomplished through selective removal of the adjustment handle 202 from one or more of the escutcheons 112, 300, for instance the interior or exterior escutcheons. As shown in FIG. 7, the escutcheon 112 (e.g., interior) is flushly positioned along the first panel interior surface 108. The flush positioning of the escutcheon 112 permits close surface to surface contact or immediately adjacent spacing (e.g., without engagement) between the first and second panels 102, 104 and thereby presents a continuous appearance between the first and second panels while allowing at the same time flush positioning of the first panel edge 114 relative to the second panel edge 116. That is to say, when the fenestration assembly 100 is viewed from the exterior or interior the escutcheon (interior 112 or exterior 300) between the panels 102, 104 is substantially concealed by panels. As described herein, the exterior escutcheon 300 is similarly flush to the panel exterior 504 and similarly facilitates positioning of the first panel 102 within the perimeter of the second panel 104 where the exterior escutcheon is interposed between the first and second panels. Stated another way, the flush mounted exterior escutcheon 300 facilitates the positioning of the panel exterior 504 (e.g., the exterior surface) of the panel 102 immediately adjacent to the panel interior (e.g., the interior surface) of the second panel 104.

In some of the examples, where a plurality of movable panels are provided the first panel of the plurality of movable panels includes the flush escutcheons capable of receiving a selectively removable adjustment handle. The user may then operate the first panel to stack each of the panels relative to each other and present a stacked appearance where each of the plurality of panels is fully contained within the border of the other panels to present an aesthetically appealing appearance and maximize the opening within the frame. Optionally, the first panel stacks each of the plurality of panels in sequence. For instance, the first panel is slid toward the open position, and movement of the first panel correspondingly moves intervening panels that are also moved and subsequently stacked as similarly shown in FIG. 6.

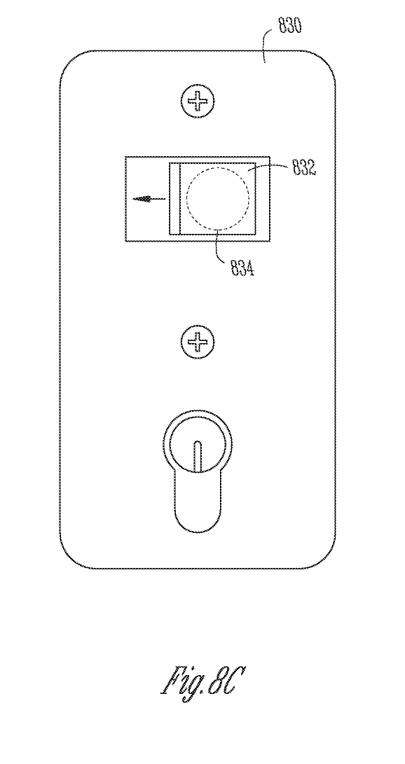

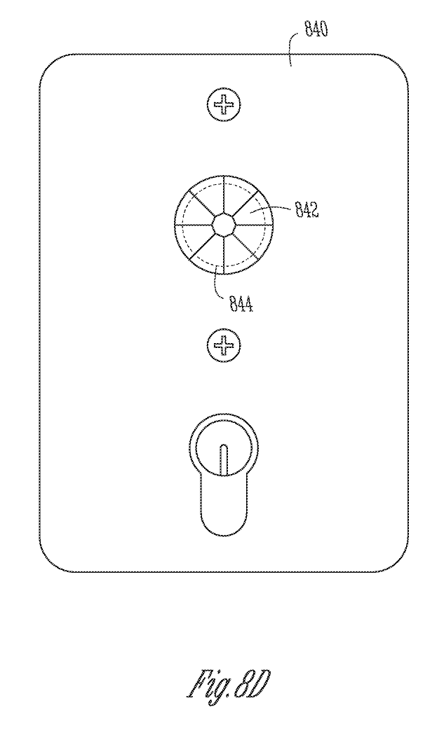

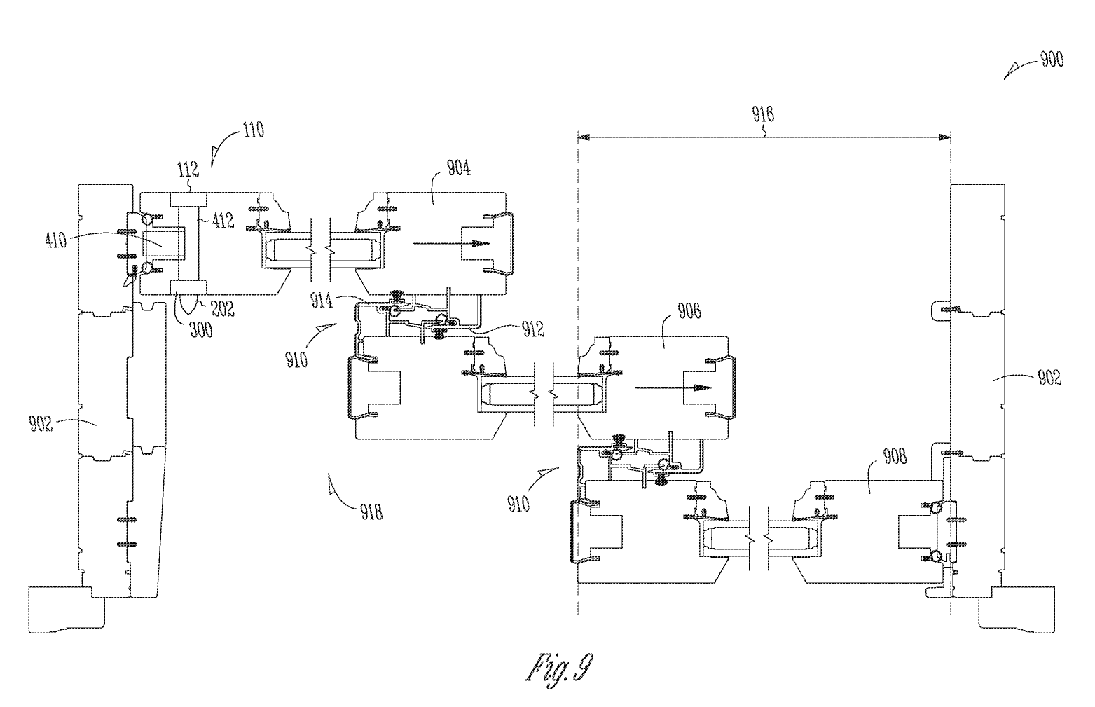

FIGS. 8A through 8D provide various examples of exterior escutcheons having movable covers. Although the description is provided for the purpose of further describing examples of the exterior escutcheon the movable covers described herein are equally applicable to the interior escutcheons as well. Referring now to FIG. 8A, one example of an exterior escutcheon 800 is shown having a movable cover including a pendulum rotating cover 802. The pendulum rotating cover 802 includes one or more pendulums 804 sized and shaped to rotatably translate across the exterior escutcheon surface 806 and access orifice 808. For instance, while the adjustment handle 202 is in position the pendulums are swung to the left and right (see the arrows in FIG. 8A) to permit access of the adjustment handle to the exterior access orifice 808. After removal of the adjustment handle 202 the pendulums are operated by one or more of gravity, spring bias and the like to swing back into the position shown in FIG. 8A and cover the exterior access orifice 808.

In one example, the escutcheons include the exterior key orifice 810 configured to allow locking and unlocking of the first panel relative to the frame with the keyed cylinder 812 to thereby selectively prevent and allow movement, respectively, of the first panel 102 relative to the frame 106.

FIG. 8B shows another example of an exterior escutcheon 820 including a in rotating disc cover 822 as a movable cover to open and close the exterior access orifice 824. As shown in FIG. 8B, the rotating disc cover 822 includes a rotating disc 826 having a crescent moon configuration with a cover orifice 828 sized and shaped to align with the exterior access orifice 824 when it is desired to couple the adjustment handle 202 with the panel adjustment mechanism 400. The adjustment handle 202 is positioned within the cover orifice 828 of the rotating disc cover 822 and the rotating disc cover is rotated through movement of the adjustment handle 202 until the cover orifice 828 of the rotating disc cover 822 aligns with the exterior access orifice 824 and the user may then engage the adjustment handle 202 within the corresponding feature of the linkage (e.g., a square or other non-circular shape configured to receive a correspondingly shaped portion of the handle).

FIG. 8C shows another example of an exterior escutcheon 830 including a sliding cover 832 sized and shaped for sliding movement of the cover to expose the exterior access orifice 834. In this example, the user either grabs through finger engagement or engagement of the adjustment handle the sliding cover 832 to move the sliding cover out of position overlying the exterior access orifice 834 and thereby allow coupling of the adjustment handle 202 within the exterior access orifice. When the adjustment handle 202 is removed the sliding cover 832 is again engaged by the user to move the cover across and conceal the exterior access orifice 834. In still another example, the sliding cover 832 is provided with a biasing mechanism, such as a spring, and the sliding cover 832 moves according to the bias when the adjustment handle 202 is removed (selectively decoupled) to thereby cover the exterior access orifice 834 and provide environmental protection to the panel adjustment mechanism 400.

FIG. 8D shows yet another example of an exterior escutcheon 840 having a webbed grommet cover 842 positioned over the exterior access orifice 844, The webbed grommet cover 842 is another example of a movable cover. In the example shown, the adjustment handle 202 (shown in other Figures herein) is pressed through the webbed grommet cover 842 to provide access to the exterior access orifice 844. The portion of the adjustment handle 202 extending through the webbed grommet cover 842 (e.g., a non-circular pin) is engaged through the exterior access orifice 844 with the linkage 410 of the panel adjustment mechanism 400 (See FIGS. 4A-D), for instance with the perimeter surfaces of a corresponding non-circular hole. For instance, the webbed grommet cover 842 includes a plastic or rubberized grommet sized and shaped to easily deflect when engaged by the adjustment handle 202, The grommet is biased to return to its covering configuration shown in FIG. 8D upon decoupling of the adjustment handle 202 from the exterior access orifice 844.

FIG. 9 shows another example of a fenestration assembly 900, for instance, a multi-panel fenestration assembly having two or more panels movable within a frame 902. Referring to FIG. 9, the fenestration assembly 900 includes first and second movable panels 904, 906 movably coupled within the frame 902. Additionally, the fenestration assembly 900 includes a third panel 908 coupled with the frame 902. In one example, the third panel 908 is a substantially static panel held within the frame 902 (e.g., the third panel does not include a panel adjustment mechanism, rollers and the like). In at least some regards, the fenestration assembly 900 includes similar features as previously described herein for the fenestration assembly 100. For instance, the fenestration assembly 900 includes a panel adjustment assembly 110 coupled with at least one of the panels such as the first panel 904. As shown in FIG. 9, the panel adjustment assembly 110 includes, in one example, exterior and interior flush mounted escutcheon 300, 112 and a panel operator 412. As shown in FIG. 9, a removable adjustment handle 202 is selectively coupled with the exterior escutcheon 300.

As previously described, the adjustment handle 202 is selectively coupled with one or more of the exterior escutcheon 300 and the interior escutcheon 112 to operate a panel adjustment mechanism 400 as previously described herein and shown in FIGS. 4A-D. For instance, the adjustment handle 202 cooperates with the panel adjustment mechanism 400 to elevate the first panel 904 relative to frame 902 and thereby facilitate rolling movement of the first panel 904, for instance, along tracks within the frame 902. In one example, each of the first panel and second panels 906 include a panel adjustment assembly configured to elevate the first and second panels 904, 906 and thereby facilitate the movement of the panels 904, 906 into a co-extensive configuration with the third panel 908.

Referring again to FIG. 9, as shown, upon actuation of the first panel 904, for instance, into a moving configuration the adjustment handle 202 is removed from the first panel 904 thereby facilitating the movement of the first panel 904 relative to the second panel 906, for instance, into a co-extensive configuration where the exterior escutcheon 300 is interposed between the first and second panels 904, 906. Upon actuation of the panel adjustment assembly 110 in one or both of the first and second panels 904, 906, the first and second panels 904, 906 are stacked in a co-extensive configuration with the third panel 908 as described above. For example, referring to FIG. 9 a panel perimeter 916 of the third panel 908 is shown. Each of the first and second panels 904, 906 are received within the panel perimeter 916. By moving the first and second panels 904, 906 into the co-extensive position with the third panel 908 the fenestration opening 918 of the fenestration assembly 900 is maximized, Where multiple panels, for instance, first through fifth movable panels are provided with the fenestration assembly 900 the space savings provided by the stacked first through fifth movable panels is maximized according to the co-extensive positioning of each of the movable panels relative to the static panel. Stated another way, with multiple panels beyond first and second movable panels 904, 906 other fenestration assemblies 900 including three or more movable panels are thereby able to realize even greater fenestration opening width because of the flush mounted escutcheons 112, 300 and the removable adjustment handle 202 (i.e., with each panel that is coextensively stacked a larger fenestration opening is provided).

Referring again to FIG. 9, the fenestration assembly 900 further includes, in one example, at least one interlock assembly 910 positioned between, for instance, the first and second panels 904, 906. In another example, a second interlock assembly 910 is provided between the second and third panels 906, 908. As shown in FIG. 9, each of the interlock assembly 910 includes a first interlock 912 associated with the first panel 904 and a second interlock 914 associated with the second panel 906. Engagement of the first and second interlocks 912, 914 provides a continuous series of panels for the fenestration assembly 900 while the first, second and third panels 904-908 are in the closed position shown in FIG. 9. Additionally, the interlock assemblies 910 facilitate the telescoping movement of the first and second panels 904, 906 of the multi-panel fenestration assembly 900. For instance, when the first and second panels 904, 906 are in the stacked configuration, for instance, where the panels are co-extensive within the panel perimeter 916 of the third panel 908, upon movement of the first panel 904 toward the closed configuration the first interlock 912 engages with the second interlock 914 to successively pull the second panel 906 into the intermediate configuration in the fenestration assembly 900 shown in FIG. 9. Stated another way, the interlock assemblies 910 ensure that the first and second panels 904, 906 always span the frame 902 and thereby close the fenestration assembly 900 upon engagement of the first panel 904 with the opposing edge of the frame 902 relative to the side of the frame 902 engaged with the third panel 908.

Optionally, the fenestration assembly 900 further includes a key cylinder such as the key cylinder 204 previously described herein. For instance, the key cylinder is exposed through corresponding orifices in one or more of the exterior and interior escutcheons 300, 112. Where the key orifice is provided in the exterior escutcheon 300 an operator may lock the first and second panels 904, 906 in the closed configuration and thereby substantially prevent the opening of the fenestration assembly 900 without the key and successive operation of the panel adjustment mechanism 400 for instance with the adjustment handle 202 selectively coupled with the exterior escutcheon 300. Stated another way, where the key cylinder 204 is provided through the exterior escutcheon 300 operation of the key cylinder 204 is required before the panel adjustment mechanism 400 may be operated, for instance, with the adjustment handle 202. The fenestration assembly 900 described herein thereby consolidates a series of panels 904, 906 that are consecutively stackable with the third panel 908 in a manner that each of the first and second panels 904, 906 are co-extensive with the panel perimeter 916 of the third static panel 908. The fenestration assembly 900 is able to stack the panels 904, 906 in this manner while at the same time providing security through a key cylinder extending through the flush mount of the exterior escutcheon 300 configured for coupling with the removable adjustment handle 202.

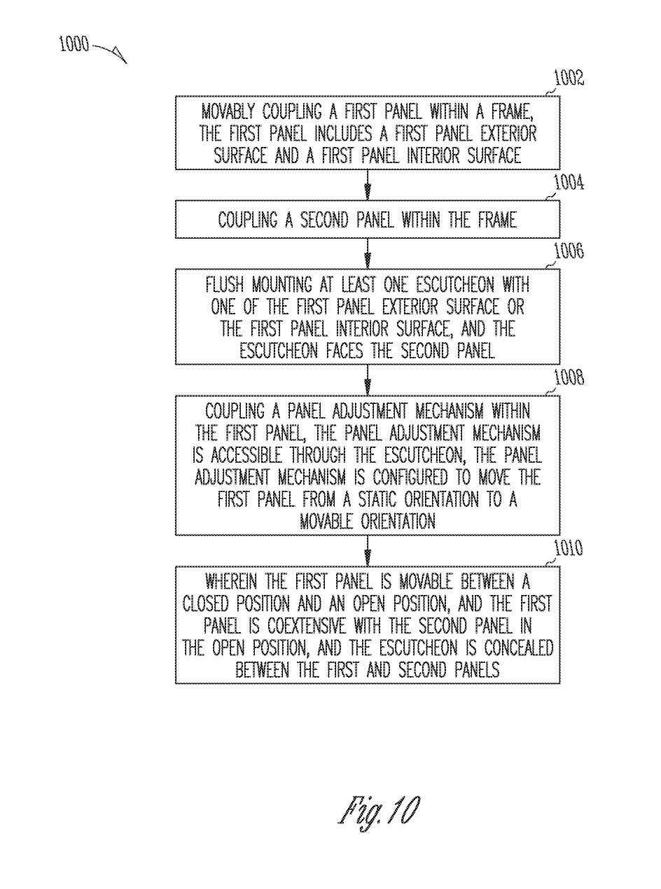

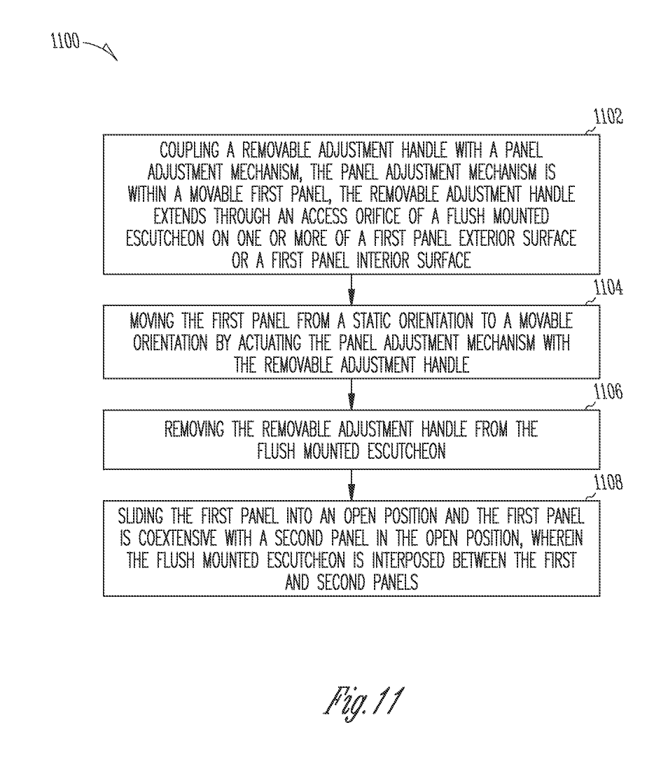

FIG. 10 shows one example of the method 1000 for making the fenestration assembly such as the fenestration assemblies 100, 900 described herein. In describing the method 1000, reference is made to features and elements previously described herein. When reference numbers are provided the numbers are not intended to be limiting. Instead, reference numbers are provided as examples and properly include similar features and elements described herein as well as their equivalents. Referring to FIG. 10, at 1002 a first panel 102 is movably coupled within a frame 106. The first panel 112 includes a first panel exterior surface 302 and a first panel interior surface 108. At 1004 a second panel 104 such as a static panel is coupled within the frame 106.

At 1006, the method 1000 includes flush mounting at least one escutcheon, for instance, an exterior or interior escutcheon 300, 112 with one of the first panel exterior 302 or the first panel interior surface 108, respectively. in one example, the at least one escutcheon 112, 300 faces the second panel 104. Stated another way, the at least one escutcheon 112, 300 is interposed between the first and second panels 102, 104 (e.g., along a face of the first panel 102 and interposed between the remainder of the first panel 102 and the second panel 104).

At 1008, a panel adjustment mechanism 400 is coupled within the first panel 102. The panel adjustment mechanism 400 is accessible through the escutcheon, for instance, through an access orifice such as an interior access orifice 500 or an exterior access orifice 306 opening to a panel operator 412. In one example, the panel adjustment mechanism 400 is configured to move the first panel 102 from the static orientation to a movable orientation (e.g., from an orientation resting on a portion of the frame 106 to a movable configuration where the first panel 102 is elevated relative to a portion of the frame 106 with rollers interposed between the first panel 102 and the frame 106). At 1010, the first panel in the movable orientation is movable from a closed position (see FIG. 1 for a partially closed configuration and FIG. 9 for a closed configuration) to an open position, such as that shown in FIG. 6. In the open position the first panel 102 is co-extensive with the second panel 104. The escutcheon, for instance, the interior escutcheon 112 or exterior escutcheon 300 is concealed between the first and second panels 102, 104. As described herein, the flush mounted escutcheon 300, 112 facilitates the positioning of the panels 102, 104 immediately adjacent to one another (e.g., within 0.125 inches of each other).

Several options for the method 1000 follow. In one example, flush mounting the at least one escutcheon 112, 300 includes fitting the at least one escutcheon 112, 300 within an installation orifice 200, 304 (see FIGS. 2 and 3). In one example, the installation orifice is on one of the first panel exterior 302 or panel interior 108. In yet another example, the method 1000 includes flush mounting a second escutcheon, such as the interior escutcheon 112 in the case where an exterior escutcheon 300 is already coupled with the first panel 102 or an exterior escutcheon 300 in the case where an interior escutcheon 112 is already coupled with the first panel 102. The second escutcheon is opposed to the at least one first escutcheon, for instance, the second escutcheon is on the exterior surface of the first panel 102 facing in an exterior direction relative to the interior escutcheon 112 facing in an interior direction.

In another example, the method 1000 further includes removably coupling an adjustment handle 202 with the panel adjustment mechanism 400 through an access orifice such as the access orifices 306, 500 on respective exterior and interior escutcheons 300, 112. In one example, the panel adjustment mechanism 400 includes a non-circular feature 502 sized and shaped for reception of a correspondingly shaped pin present on the adjustment handle 202. Optionally, the non-circular feature 502 is included in the panel operator 412 (See FIGS. 4E, F) and is part of the panel adjustment assembly 110. In another example, the method 1000 includes coupling a movable cover with at least one of the escutcheons 112, 300. For instance, with the exterior escutcheon 300 a movable cover 308 is provided that covers the exterior access orifice 306 upon removal of the adjustment handle 202 from the exterior access orifice 306. In one example, the movable cover 308 is biased to cover the access orifice 306 when the adjustment handle 202 is decoupled from the escutcheon 300 and the panel adjustment mechanism 400. For instance, the movable cover 308 includes a spring, or is biased by gravity and the like to move into a covering orientation over the exterior access orifice 306. In still another example, the method 1000 includes decoupling the adjustment handle 202 from the panel adjustment mechanism 400 and one or more of the escutcheons 112, 300 while the first panel 102 is in the closed position. For instance, the adjustment handle 202 is decoupled from the first panel 102 to substantially fix or statically orient the first panel 102 within the frame 106 to thereby close and retain the first panel 102 in a closing configuration within the fenestration assembly 100.

In yet another example, the method 1000 includes coupling a key cylinder 204 with the panel adjustment mechanism 400. The at least one escutcheon 112, 300 (one or more of the interior and exterior escutcheons) includes a key orifice 206, 310 extending through the at least one escutcheon 112, 300 to the key cylinder 204. The key cylinder 204 selectively permits and prohibits operation of the panel adjustment mechanism 400. Stated another way, with the key cylinder locking the panel adjustment mechanism 400, in order to move the first panel 102 into the open configuration (shown in FIG. 6) a key must be inserted into the key cylinder 204 and rotated to unlock the mechanism 400 for operation by the adjustment handle 202.

In another example, coupling the panel adjustment mechanism 400 within the first panel 102 includes interposing the mechanism body 402 between the first panel 102 and the frame 106. In another example, coupling the panel adjustment 400 with the first panel 102 further includes coupling a linkage 410 between the at least one escutcheon 112, 300 and the mechanism body 402. In yet another example, interposing the mechanism body 402 between the first panel 102 and the frame 106 includes coupling one or more rollers 404 with the mechanism body 402, In the movable orientation, for instance, with operation of the panel adjustment mechanism 400 the one or more rollers are movably engaged along the frame 106 to permit movement of the first panel 102 from the closed to the open configuration and back again into the closed configuration.

FIG. 11 shows one example of a method 1100 for using a panel adjustment assembly 110 with a lift and slide door, for instance a first panel 102 of a fenestration assembly 100. Reference numbers are provided for features and elements recited in the description of the method 1100. The reference numbers provided are exemplary and not intended to be limiting. Features and elements recited in the description 1100 thereby include all similar features and elements described herein as well as their equivalents.

At 1102, a removable adjustment handle 202 is coupled with a panel adjustment mechanism 400, for instance a linkage 410 and a mechanism body 402 within a first panel 102 by way of a panel operator 412. In one example, the adjustment handle 202 coupled with the panel adjustment mechanism 400 (through at least one escutcheon 300, 112 and the panel operator 412) provides the assembly of the handle and the mechanism in an operation configuration. The removable adjustment handle 202 extends through an access orifice 306, 500 of a flush mounted escutcheon (e.g., one or more of an exterior or interior escutcheons 300, 112). The flush mounted escutcheon 300, 112 is flush with one of the respective first panel exterior surface 302 or first panel interior surface 108. As described herein, the flush mounted escutcheons 300, 112 allow for positioning of the first panel 102 into a coextensive position with the second panel 104. The flush profile of the exterior or interior escutcheons 300, 112 relative to the first panel 104 allows for positioning of the perimeter of the first panel 102 within the perimeter of the second panel 104.

At 1104, the first panel 102 is moved from a static orientation to a movable orientation by actuating the panel adjustment mechanism 400 with the removable adjustment handle 202. For example, the removable adjustment handle 202 is rotated and a non-circular pin on the handle correspondingly rotates the panel operator 412 including a complementary non-circular feature (e.g., feature 502 shown in FIG. 5A). Operation of the panel adjustment mechanism 400 lifts the first panel 102 relative to the frame 106. As shown in FIG. 4B, operation of the panel adjustment mechanism 400 lifts the first panel 102 relative to the mechanism body 402, for instance with an elevation arm 406, The rollers 404 are engaged along the frame 106 and allow for movement of the first panel 102 between closed and open positions.

Optionally, at least the first panel 102 includes a key cylinder 204 with one or more key orifices 310, 206 in one or both of the respective exterior and interior escutcheons 300, 112. Moving the first panel 1104, in one example, includes first operating the key cylinder 204 to unlock the panel adjustment mechanism 400. They key cylinder 204 thereby provides a security feature that prevents undesired opening of the fenestration assembly, for instance, from the exterior where the assembly includes an exterior flush mounted escutcheon 300.

At 1106, the method 1100 includes removing the removable adjustment handle 202 from the flush mounted escutcheon 300, 112 after actuation of the panel adjustment mechanism 400 into the movable orientation. Removal of the adjustment handle 202 transitions the assembly of the handle and the escutcheon (300 or 112) into a flush configuration from the operation configuration.

At 1108, the first panel 102 is slid into an open position. The first panel 102 is coextensive with the second panel 104 (e.g., the first and second panel edges 114, 116 are flush). For instance, the perimeter of the first panel 102 is substantially within the perimeter of the second panel 104, thereby maximizing the opening of the fenestration assembly 600. As shown in FIG. 6, because the flush escutcheon (exterior or interior 300, 112) is interposed between the first and second panels 102, 104 without the adjustment handle 202 the first panel 102 is movable to the coextensive position with second panel 104. Removal of the adjustment handle 202 and the flush escutcheon ensures the first panel 102 is movable to a coextensive configuration without interference by a projecting handle.

Optionally, the method 1100 includes moving a plurality of panels (two or more panels) into a coextensive configuration with a static panel as shown in FIG. 9. In one example, each of the movable panels includes a separately operable panel adjustment mechanism 400. Operation of each of the panel adjustment mechanisms 400 for each respective panel (e.g., 904, 906) moves the panels into movable configurations for coextensive positioning with a static panel 908. One or more of the panels 904, 906 include flush mounted escutcheons (300, 112) to allow for the coextensive positioning of the panels 904, 906 with the static panel 908.

### CONCLUSION

The panel adjustment assemblies described herein provide flush mounted features that facilitate the stacking of one or more of a plurality of panels of a fenestration assembly. As described above, one or more of interior and exterior flush mounted escutcheons including key cylinders presented through the escutcheons are substantially flush relative to the panel interior and exterior surfaces. An adjustment handle is selectively coupled with a panel adjustment mechanism (for instance through a panel operator installed beneath the flush mounted escutcheons) that actuates the panel into a movable configuration according to operation of the handle. When operation of the handle and the panel adjustment mechanism is not desired, the adjustment handle is removed from the panel.

As described herein, the panel adjustment assembly includes one or more of interior and exterior escutcheons flush mounted with a panel (e.g., a movable first panel within a frame of a fenestration assembly). The escutcheons provide access to a panel adjustment mechanism that facilitates movement of the first panel. For instance, the adjustment handle is selectively coupled with the panel adjustment mechanism through an access orifice of the escutcheon. After operation of the adjustment handle to move the panel into a movable configuration, the handle or the panel are pulled or pushed to move the panel into a stacked configuration with at least one other panel of the fenestration assembly. In one example, all of the features presented at the escutcheons are substantially flush or recessed with respect to the respective interior and exterior surfaces of the panel to ensure movement of the first panel behind a second panel is not interrupted by engagement between projecting features. Escutcheon features include, but are not limited to, key cylinders and key orifices, exterior access orifices for the handle, movable covers positionable over the exterior access orifices and the like. Each of these features are substantially contained within the flush mounted escutcheons or positioned behind the escutcheons to ensure the first panel is movable into a stacked configuration with the second panel. Minimal spacing is provided between the panels (e.g., around 0.125 inches) because of the flush contour of the panel adjustment assembly to substantially avoid a gap between the panels otherwise required with projecting handles, escutcheons and the like. Thick interlocking features between adjacent panels that allow for reception of a handle and projecting features of the panels are thereby avoided.

With the stacked configuration the first panel is movable into a stacked position that is coextensive with the position of the second panel, Stated another way, the first panel is positioned within the perimeter of the second panel to provide the largest possible opening through the fenestration frame (e.g., the side edges of each panel are substantially flush). Additionally, the stacked configuration provides a clean aesthetic appearance by visibly consolidating the first and second panels. In contrast, in previous fenestration assemblies the first panel is staggered relative to the second panel and thereby still visible because of projecting handles, escutcheons, latches and the like. Furthermore, where multiple panels (e.g., three or more panels) are included in larger fenestration assemblies, the panel adjustment assembly described herein facilitates the consecutive stacking of two or more panels to maximize the opening within the fenestration frame. Stated another way, multiple edges of panels are not presented in a staggered fashion, instead the panels are stacked with each panel substantially coextensive with the other panels.

Further, as described herein the adjustment handle is selectively coupled (e.g., readily removable by the operator) with the panel adjustment mechanism. In the open position, described above, removal of the adjustment handle cooperates with the flush escutcheons to allow the coextensive positioning of the first panel relative to the second panel (e.g., the flush positioning of one of the first panel behind the second panel). In the closed position with the panels spanning the fenestration frame, removal of the adjustment handle provides a clean aesthetically pleasing look to the fenestration assembly.

Further still, the combination of at least the flush exterior escutcheon with a key cylinder provides enhanced security while at the same time providing a fenestration assembly with stackable panels. Stated another way, the adjustment handle is removable from an exterior escutcheon and prevents actuation of the panel into a movable configuration. Provision of the key cylinder through an exterior key orifice in the exterior escutcheon provides a feature to lock the panel adjustment mechanism, for instance at the panel operator, to further enhance the security of the fenestration assembly. The user is thereby able to lock and unlock the fenestration assembly from the exterior, operate the panels into movable configurations with the adjustment handle at the exterior flush mounted escutcheon and stack the panels coextensively after removal of the adjustment handle.

In the foregoing description, the subject matter has been described with reference to specific exemplary examples. However, it will be appreciated that various modifications and changes may be made without departing from the scope of the present subject matter as set forth herein. The description and figures are to be regarded in an illustrative manner, rather than a restrictive one and all such modifications are intended to be included within the scope of the present subject matter. Accordingly, the scope of the subject matter should be determined by the generic examples described herein and their legal equivalents rather than by merely the specific examples described above. For example, the steps recited in any method or process example may be executed in any order and are not limited to the explicit order presented in the specific examples. Additionally, the components and/or elements recited in any apparatus example may be assembled or otherwise operationally configured in a variety of permutations to produce substantially the same result as the present subject matter and are accordingly not limited to the specific configuration recited in the specific examples.

Benefits, other advantages and solutions to problems have been described above with regard to particular examples; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present subject matter, addition to those not specifically recited, may be varied or otherwise particularly adapted to specific environments, manufacturing specifications, design parameters or other operating requirements without departing from the general principles of the same.

The present subject matter has been described above with reference to examples. However, changes and modifications may be made to the examples without departing from the scope of the present subject matter. These and other changes or modifications are intended to be included within the scope of the present subject matter, as expressed in the following claims.

It is to be understood that the above description is intended to be illustrative, and not restrictive. Many other examples will be apparent to those of skill in the art upon reading and understanding the above description. It should be noted that examples discussed in different portions of the description or referred to in different drawings can be combined to form additional examples of the present application. The scope of the subject matter should, therefore, be determined with reference to the appended claims, along with the full scope of equivalents to which such claims are entitled.

What is claimed is:

1. A fenestration assembly comprising:
a frame;
a first panel movably coupled within the frame, the first panel includes a first panel exterior surface and a first panel interior surface, the first panel is movable between a dosed position and an open position;
a second panel coupled within the frame;
a first escutcheon coupled along one of the first panel exterior surface or the first panel interior surface, the first escutcheon is flush mounted relative to the first panel exterior surface or the first panel interior surface, and the first escutcheon faces the second panel;
a panel adjustment mechanism within the first panel, the panel adjustment mechanism is accessible through the first escutcheon, the panel adjustment mechanism is configured to move the first panel from a static orientation to a movable orientation; and
wherein the first panel is coextensive with the second panel in the open position, and the first escutcheon is concealed between the first and second panels.

2. The fenestration assembly of claim 1 comprising a key cylinder coupled with the panel adjustment mechanism, and the first escutcheon includes a key orifice extending through the first escutcheon to the key cylinder, and the key cylinder selectively permits and prohibits operation of the panel adjustment mechanism.

3. The fenestration assembly of claim 1, wherein the first escutcheon includes an access orifice.

4. The fenestration assembly of claim 3 comprising an adjustment handle removably coupled with the panel adjustment mechanism through the access orifice.

5. The fenestration assembly of claim 4, wherein the first escutcheon includes a movable cover, and the movable cover covers the access orifice when the adjustment handle is decoupled from the panel adjustment mechanism.

6. The fenestration assembly of claim 5 wherein the movable cover consists of a rotating disc cover, a pendulum rotating cover, a sliding cover or a webbed grommet cover.

7. The fenestration assembly of claim 1, wherein the panel adjustment mechanism includes:
a mechanism body coupled with the first panel, and the mechanism body is interposed between the first panel and the frame, and
a linkage extending from the first escutcheon to the mechanism body.

8. The fenestration assembly of claim 7, wherein the mechanism body includes a plurality of rollers for moving of the first panel in the movable orientation.

9. The fenestration assembly of claim 1, wherein one of the first panel interior or exterior surfaces including the first escutcheon is immediately adjacent to one of a second panel exterior surface or a second panel interior surface in the open position according to the flush mounting of the first escutcheon.

10. The fenestration assembly of claim 1, wherein a first panel edge of the first panel adjacent to the first escutcheon is flush with a second panel edge of the second panel in the open position.

11. The fenestration assembly of claim 1 comprising a second escutcheon coupled along one of the first panel interior surface or the first panel exterior surface and opposed to the first escutcheon, wherein the second escutcheon is flush mounted relative to the first panel interior surface or the first panel exterior surface.

12. The fenestration assembly of claim 1, wherein the static orientation includes the first panel engaged with a portion of the frame, and die movable orientation includes the first panel elevated relative to the portion of the frame.

13. A panel adjustment assembly comprising:
a panel adjustment mechanism configured to move a panel from a static orientation to a movable orientation when the panel is coupled with a frame of a fenestration assembly;
an exterior escutcheon configured for flush mounting along an exterior surface of the panel, the exterior escutcheon includes a first access orifice extending through the exterior escutcheon;
an adjustment handle removably coupled with the exterior escutcheon; and
wherein the exterior escutcheon and the adjustment handle include an operation configuration and a flush configuration, in the operation configuration the adjustment handle is coupled with the panel adjustment mechanism through the first access orifice, and in the flush configuration the adjustment handle is decoupled from the panel adjustment mechanism and the exterior escutcheon.

14. The panel adjustment assembly of claim 13 comprising an interior escutcheon, the interior escutcheon is configured for flush mounting along an interior surface of the panel and is opposed to the exterior escutcheon on the exterior surface of the panel.

15. The panel adjustment assembly of claim 14, wherein the interior escutcheon includes a second access orifice, and the adjustment handle is removably coupled with die panel adjustment mechanism through one of the first or second access orifices of the exterior or interior escutcheons.

16. The panel adjustment assembly of claim 13, wherein the exterior escutcheon includes a movable cover, and the movable cover covers the first access orifice when the adjustment handle is decoupled from the panel adjustment mechanism.

17. The panel adjustment assembly of claim 13 comprising a key cylinder coupled with the panel adjustment mechanism, and the exterior escutcheon includes a key orifice extending through the exterior escutcheon to the key cylinder, and the key cylinder selectively permits and prohibits operation of the panel adjustment mechanism.

18. The panel adjustment assembly of claim 17 comprising an interior escutcheon configured for flush mounting along an interior surface of the panel, and the interior escutcheon includes a second key orifice extending through the interior escutcheon to the key cylinder.

19. The panel adjustment assembly of claim 13 comprising a panel operator coupled with the exterior escutcheon, wherein the panel operator is coupled with the panel adjustment mechanism, and the panel operator is accessible through the first access orifice of the exterior escutcheon.

20. The panel adjustment assembly of claim 13, wherein the panel adjustment mechanism includes a linkage configured to elevate a panel into the movable orientation from the static orientation.

21. A method for making a fenestration assembly comprising:
movably coupling a first panel within a frame, the first panel includes a first panel exterior surface and a first panel interior surface;
coupling a second panel within the frame;
flush mounting at least one escutcheon with one of the first panel exterior surface or the first panel interior surface, and the escutcheon faces the second panel;
coupling a panel adjustment mechanism within the first panel, the panel adjustment mechanism is accessible through the escutcheon, the panel adjustment mechanism is configured to move the first panel from a static orientation to a movable orientation; and
wherein the first panel is movable between a closed position and an open position, and the first panel is coextensive with the second panel in the open position, and the escutcheon is concealed between the first and second panels.

22. The method of claim 21 comprising coupling a key cylinder with the panel adjustment mechanism, the at least one escutcheon includes a key orifice extending through the at least one escutcheon to the key cylinder, and the key cylinder selectively permits and prohibits operation of the panel adjustment mechanism.

23. The method of claim 21, wherein flush mounting the at least one escutcheon includes fitting the at least one escutcheon within an installation orifice of the first panel exterior surface or the first panel interior surface.

24. The method of claim 21 comprising removably coupling an adjustment handle with the panel adjustment mechanism through an access orifice in the escutcheon in the closed position.

25. The method of claim 24 comprising coupling a movable cover with the at least one escutcheon, the movable cover is biased to cover the access orifice when the adjustment handle is decoupled from the escutcheon and the panel adjustment mechanism.

26. The method of claim 24 comprising decoupling the adjustment handle from the panel adjustment mechanism and the escutcheon in the dosed position.

27. The method of claim 21 comprising flush mounting a second escutcheon with one of the first panel interior surface and the first panel exterior surface, the second escutcheon is opposed to the at least one escutcheon.

28. The method of claim 21, wherein coupling the panel adjustment mechanism within the first panel includes:
interposing a mechanism body between the first panel and the frame, and
coupling a linkage between the at least one escutcheon and the mechanism body.

29. The method of claim 28, wherein interposing a mechanism body between the first panel and the frame includes coupling one or more rollers with the mechanism body, and in the movable orientation the one or more rollers are movably engaged along the frame.
